(19) United States
(12) Patent Application Publication
(10) Pub. No.: US 2007/0151435 A1
(43) Pub. Date: Jul. 5, 2007

(54) PUNCH HEAD HOUSING

(75) Inventor: Balaji Kandasamy, Naperville, IL (US)

Correspondence Address: MICHAEL BEST & FRIEDRICH, LLP, 100 EAST WISCONSIN AVENUE, SUITE 3300, MILWAUKEE, WI, 53202, US

(73) Assignee: ACCO BRANDS USA LLC, Lincolnshire, IL (US)

(21) Appl. No.: 11/616,981

(22) Filed: Dec. 28, 2006

Related U.S. Application Data
(60) Provisional application No. 60/754,907, filed on Dec. 29, 2005.

(51) Int. Cl. B26D 5/08

(52) U.S. Cl. 83/588; 83/618; 83/620; 83/627

(57) ABSTRACT

A punch head includes a punch pin and a punch housing supporting the punch pin. The punch housing includes a slot for receiving one or more workpieces to be punched. The slot defines a stack height SH. The punch housing further includes first and second walls, at least one of the first and second walls defining a wall thickness T. Each of the first and second walls also includes an aperture for receiving a pivot pin coupling a punch pin actuation member to the punch housing. A ratio of the wall thickness T to the stack height SH is greater than 0.9.

### RELATED APPLICATIONS

This application claims the benefit of U.S. Provisional Patent Application No. 60/754,907 filed Dec. 29, 2005, the entire contents of which is incorporated by reference herein.

### BACKGROUND

The present invention relates to a punch. More particularly, the invention relates to a housing for a punch head of the punch.

Paper tools, including paper punches, staplers, and paper trimmers, are configured such that force input by a user results in an operation on paper or other substrates. For example, in a paper punch, the user actuates a handle or a lever, which causes a punch pin guided within a punch head housing to move and punch a hole in a stack of sheets inserted into the punch.

It is known to provide an aperture in some punch head housings that is configured to retain the pivot shaft about which the actuating handle of the punch pivots. These types of “integrated pivot” punch head housings are typically used on small, one hole punches designed for punching up to about eight sheets.

### SUMMARY

Prior art integrated pivot punch head housings utilize a multiple piece (e.g., two piece) punch housing configuration, with the housing pieces being welded or coupled together using fasteners, such as rivets. Typically, the multiple pieces are individually stamped from sheet metal and are then aligned and coupled together using the processes described above. The multiple piece configuration is more costly to make, as multiple parts and multiple construction steps are required. The types of materials that can be used to make the housing are also limited, due to stamping and strength constraints. Assembling multiple piece punch housings also presents issues with tolerances and punch pin hole alignment. Further, the multiple piece configuration does not have the desired strength to make such a housing usable in paper punches capable of punching more than about eight sheets. With more than about eight sheets, prior art multiple piece housings commonly experience relative movement or deflection of the housing pieces, making punching difficult and jeopardizing the structural integrity of the housing. It is thus desirable to provide a punch that includes a housing that is easier and less expensive to make, and that eliminates many of the alignment and tolerancing issues found in assembling the prior art multiple piece punch housings. It is further desirable to produce such a punch housing that can be utilized in a full range of punches, from pocket sized one hole punches designed to punch up to twelve sheets, to multiple hole punches designed to punch up to twenty or more sheets.

The present invention relates to a paper punch for acting on a workpiece, such as a stack of sheets. The punch includes a punch head having a punch pin that acts upon the stack of sheets. A punch housing supports the punch pin and includes apertures through which the punch pin moves. The punch also includes a base that at least partially defines a slot into which the stack of sheets is received.

In one embodiment, the punch housing is an integrally-formed, one piece unit having a top wall, sidewalls, and a bottom wall. The sidewalls have a thickness, and the housing defines a slot having a stack height. The ratio of the wall thickness to the stack height is greater than 0.9. In one embodiment, the ratio is greater than or equal to 1.0. The sidewalls can also define a drive slot that allows for vertical movement of a cross pin with respect to the base, and a pivot pin aperture that allows for horizontal movement of a pivot pin with respect to the base. The pivot pin aperture is an enclosed aperture, which increases the overall strength of the sidewall.

In one embodiment, the housing is cast of an appropriate material, such as zinc or a zinc alloy. In another embodiment, the housing includes apertures configured to receive a portion of the base of the punch to couple the housing to the punch. In some embodiments, the apertures are stepped such that a first portion of the aperture has a first diameter, and a second portion of the aperture has a second diameter. In yet other embodiments, the aperture in the bottom wall of the housing through which the punch pin passes during punching operations is flush with the bottom surface of the bottom wall, and no additional depending support member is required.

Other aspects of the invention will become apparent by consideration of the detailed description and accompanying drawings.

### BRIEF DESCRIPTION OF THE DRAWINGS

FIG. 1 is a side view of a punch embodying aspects of the present invention.

FIG. 2 is a rear view of the punch of FIG. 1.

FIG. 3 is a rear perspective view of the punch of FIG. 1.

FIG. 4 is a front perspective view of the punch housing of the punch of FIG. 1.

FIG. 5A is a bottom view of the punch housing of FIG. 4.

FIG. 5B is a front view of the punch housing of FIG. 4.

FIG. 5C is a side view of the punch housing of FIG. 4.

FIG. 5D is a section view of the punch housing of FIG. 5B, taken along line 5D-5D.

FIG. 5E is a top view of the punch housing of FIG. 4.

FIG. 6 is a perspective view of the punch of FIG. 1 shown disassembled from a punch guide.

FIGS. 7A and 7B are perspective views of the punch of FIG. 1 shown assembled with the punch guide and in use.

FIG. 8 is a perspective view of a two-hole punch using the punch head of FIG. 4.

FIG. 9 is a perspective view of a three-hole punch using the punch head of FIG. 4.

FIG. 10 illustrates a prior art multiple piece punch housing construction.

FIG. 11 illustrates a bottom view of the prior art housing of FIG. 10.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

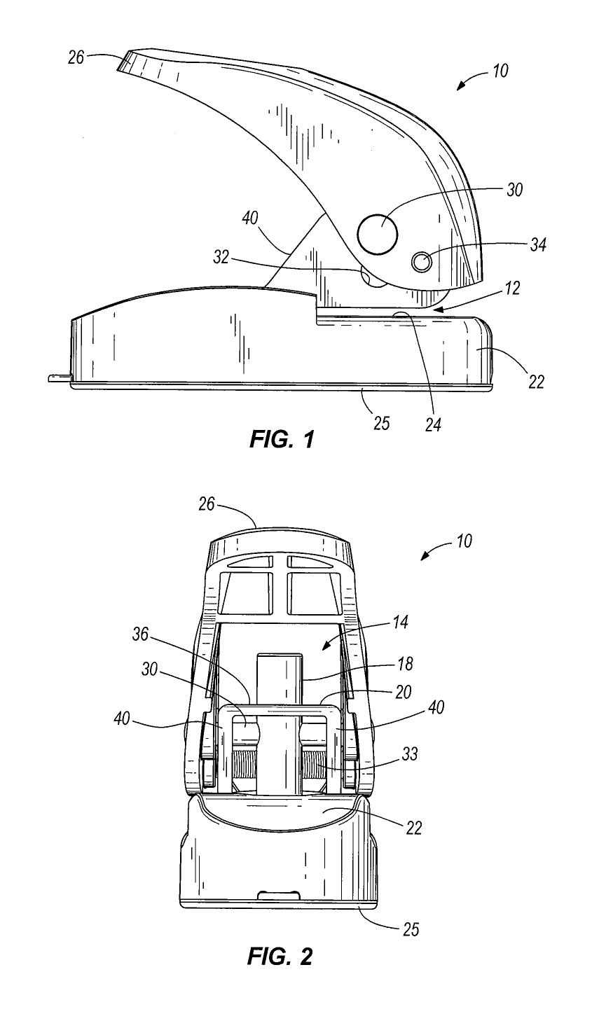

FIGS. 1-3 illustrate a punch 10 that is preferably configured to perform a punching operation on a workpiece, such as displacing, preferably by shearing, a piece of a workpiece with respect to the remainder of the workpiece, punching a hole or stamping a depression or countersink in the workpiece, stamping to form a raised or depressed feature in a workpiece or embossing the workpiece. Typical workpieces for use with punches of the present invention include paper, cardboard, plastic, and the like. Typically, the workpieces are in the form of one or more sheets such as a single sheet of paper or a stack of sheets. In one embodiment, the punch 10 is configured to punch at least one hole in a sheet of paper or stack of paper sheets. The punch 10, in its illustrated configuration and orientation, is configured to receive the paper within a slot 12 in a substantially horizontal orientation, though it is understood that the punch can be oriented in any suitable orientation (e.g., by hand) and can have other configurations, including configurations permitting generally vertical insertion of the paper.

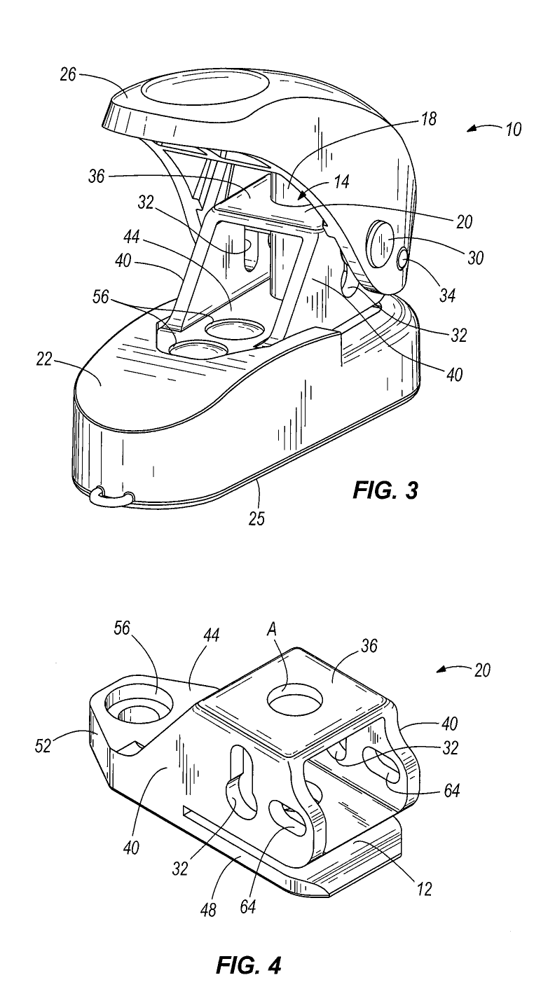

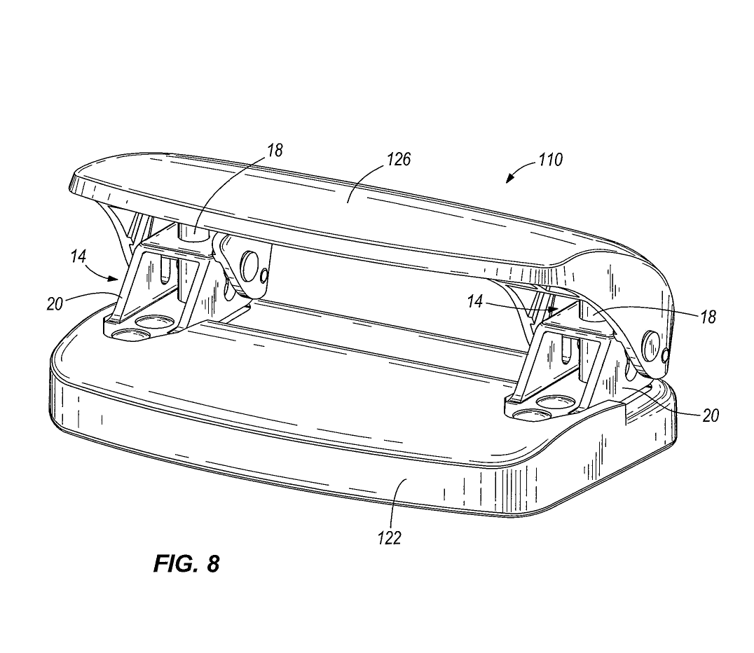

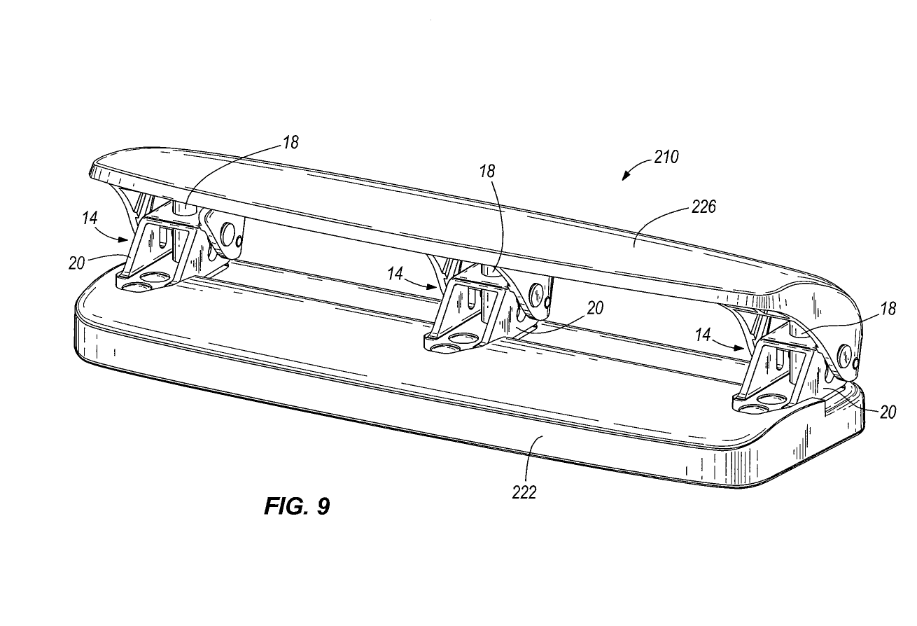

As illustrated in FIGS. 2 and 3, the punch 10 includes a punch head 14 configured to perform the punching operation. While the punch shown in the illustrated embodiment includes a single punch head 14, it is understood that in other embodiments the punch can utilize two, three, or more punch heads and still fall within the scope of the present invention. For example, FIG. 8 illustrates the use of the punch head 14 in a two-hole punch 110, and FIG. 9 illustrates the use of the punch head 14 in a three-hole punch 210. Like parts have been given like reference numerals in FIGS. 8 and 9, while similar parts have been given reference numerals of the 100 and 200 series, respectively. The punch head 14 includes a punch pin 18 movable through a punch pin path, and a punch housing 20 that supports the punch pin 18 and through which the punch pin 18 moves. In embodiments where more than one punch head 14 is employed (see FIGS. 8 and 9), each punch head 14 can include a separate punch housing 20. Additional features of the punch housing 20 will be discussed in detail below.

The punch 10 also includes a base 22 configured to support the punch 10 on a support surface, the base 22 supporting the punch housing 20 thereon. In some embodiments, such as the punch 10 of FIGS. 1-3, the punch 10 is configured such that the punch can be used as a handheld punch, and thus the base 22 is also configured to rest comfortably within the hand of the user. The base 22, along with the punch housing 20, defines the slot 12 into which the workpiece (e.g., paper) is received, and provides a paper support surface 24. The base 22 also defines a cavity into which pieces of paper removed by the punch pin 18, commonly called chips, can fall and collect. A removable slipper 25 encloses the cavity and allows the user to periodically empty the chips from the cavity.

The punch 10 also includes a handle or actuation member 26 that is configured to receive force input from a user of the punch 10. In the illustrated embodiment, the handle 26 is rotatable with respect to the base 22 and the housing 20. The handle 26 is coupled to the housing 20 via a cross pin 30 (shown in FIGS. 1-3 with plastic caps on the ends) that extends through slots 32 in the housing 20, as will be discussed below. The cross pin 30 also extends through the punch pin 18 such that rotation of the handle 26 causes movement of the cross pin 30, which in turn drives the punch pin 18 up and down to perform the punching operation. The slots 32 in the housing 20 are configured to allow for the up and down motion of the cross pin 30 during punching operations. Alternative arrangements, such as a button, lever, or the like may also be employed to impart the actuation motion. A motor, such as an electrical motor, may also be used to impart the actuation motion.

In the rest position shown in FIG. 1, the handle 26 is biased away from the base 22 via a spring 33 (shown in FIG. 2) that is coiled about a pivot pin 34 that also extends through the front of the handle 26 and the housing 20. The handle 26 pivots about the pivot pin 34 during punch operations. Manual force input by the user into the handle 26 overcomes the bias of the spring 33 to move the punch pin 18 down into the stack of sheets. Once the user releases the handle 26, the bias of the spring 33 returns the handle 26 to the rest position.

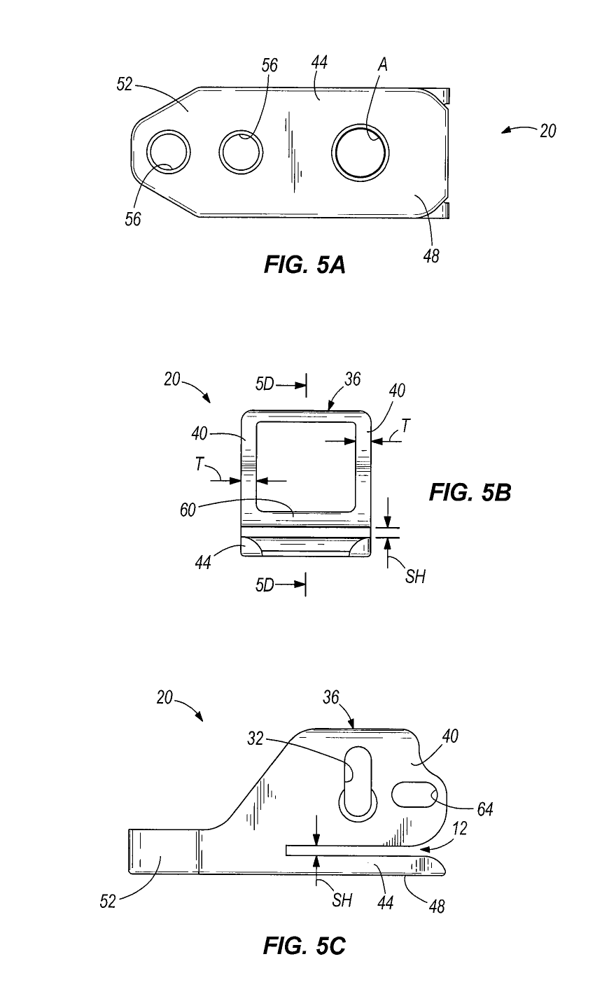

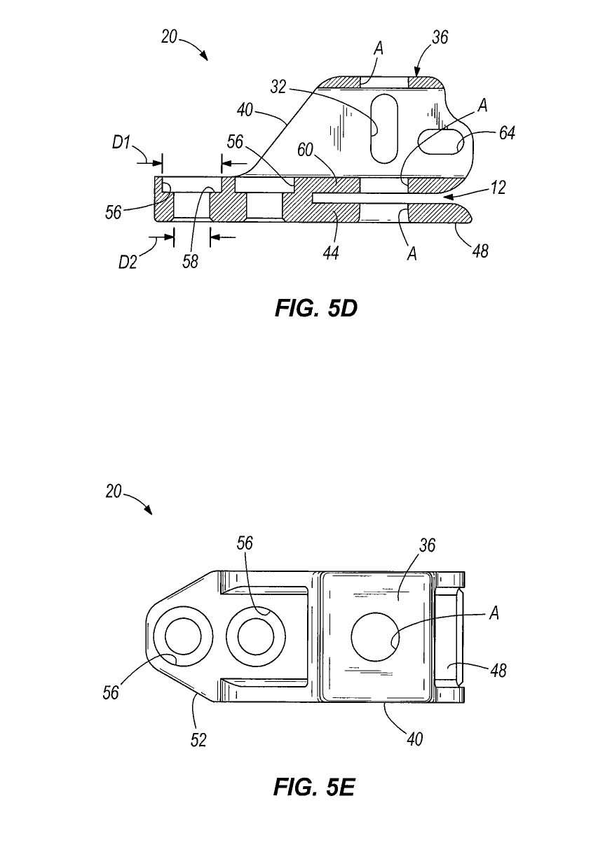

Referring now to FIGS. 4-5E, the punch housing 20 includes a top wall 36, two sidewalls 40, and a bottom wall 44. It should be understood that the use of descriptive terms such as “top,” “bottom,” “side,” “front,” and “rear” in this application is for reference to the drawings only, and such terms are not intended to imply that a specific orientation of the components is necessary to fall within the scope of the present invention. Rather, the use of these terms is for ease of description only, and the terms do not imply a particular orientation of the parts described herein.

The illustrated punch housing 20 is cast as a single piece, with all the components of the punch housing 20 being integrally formed. The one piece construction of the punch housing 20 has many benefits over the prior art multiple piece constructions, as the integral construction reduces construction costs, eliminates the need for aligning multiple pieces during the assembly process (eliminating tolerancing and alignment errors during construction), and increases the overall strength of the housing, as will be discussed in more detail below. The punch housing 20 of the illustrated embodiment is cast from a zinc alloy, though it is understood that any other materials capable of casting, such as aluminum, etc., can be used and still fall within the scope of the present invention. In some embodiments, the housing could also be formed of plastic or other hardened material suitable for supporting the punch pin 18.

The bottom wall 44 includes a front portion 48 that at least partially defines the slot 12, and a rear portion 52. The rear portion 52 includes apertures 56 that receive a portion of the base 22 of the punch 10 to couple the housing 20 to the base 22. As best seen in FIGS. 4 and 5D, the apertures 56 are stepped, in that the apertures have a first, larger diameter D1 near the top of the rear portion 52, and a second, smaller diameter D2 near the bottom of the rear portion 52. In some embodiments, the portion of the base 22 that is received within the apertures 56 to couple the housing 20 to the base 22 is a plastic protrusion. Once the protrusion is inserted into the aperture 56, the top portion of the protrusion is melted and the melted plastic pools within the aperture 56. A ledge 58 (see FIG. 5D) is created within the aperture 56 by the reduction of the diameter from D1 to D2. The melted plastic pools on the ledge 58 such that when the plastic cools, the cooled plastic has conformed to the larger diameter D1 such that the plastic can no longer be withdrawn from the aperture 56 through the smaller diameter D2. Thus, the housing 20 is securely coupled to the base 22. Those skilled in the art will understand that there are also other suitable methods for coupling the base 22 to the housing 20.

The housing 20 also includes an intermediate wall 60 that is generally parallel to the bottom wall 44 and that defines the top of the slot 12. As best shown in FIG. 5D, the top wall 36, intermediate wall 60, and front portion 48 of the bottom wall 44 each include an aperture A, the apertures A being aligned and configured to receive and guide the punch pin 18 during punching operations. Since the illustrated housing 20 is integrally formed by casting, an automatic alignment of the apertures A in the respective walls 36, 60, 44 occurs when the apertures A are machined in a single step into the already cast housing. In some embodiments, the apertures A can be cast into the housing 20 during the casting process using a die. These aperture formation processes eliminate the difficulties that occur during the assembly of the multiple piece punch housings of the prior art, which require alignment of the holes that are stamped into the separate parts. Misalignment of the apertures A could cause interference with the movement of the punch pin 18 during punching operations, and could cause unnecessary wear of the punch pin, as well as reduced efficiency of the punching operation.

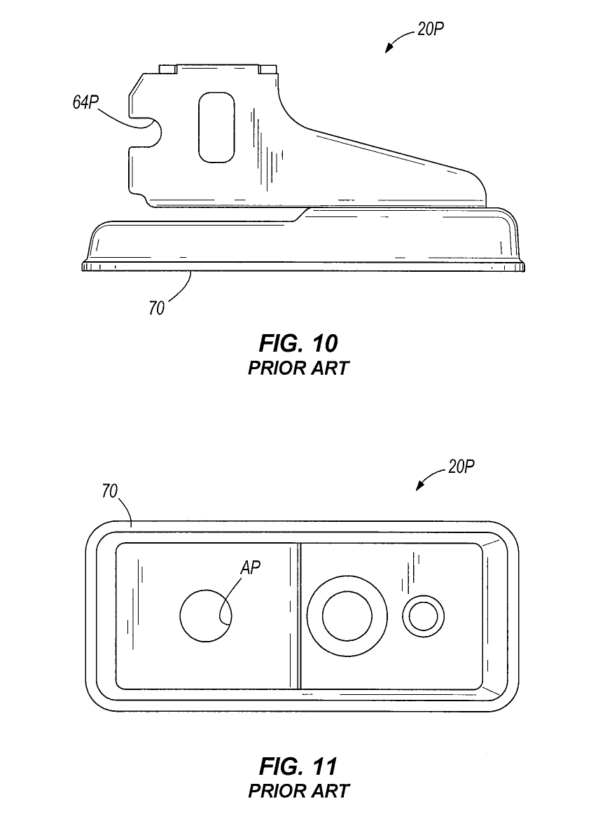

As best shown in FIGS. 5A and 5D, the aperture A in the bottom wall 44 defines the cutting edge against which the punch pin 18 acts to punch the chips out of a stack of sheets. The aperture A extends through the entirety of the bottom wall 44 and is flush with the bottom side of the bottom wall 44. In prior art multiple piece housing configurations, such as the two piece housing 20P shown in FIGS. 10 and 11, an additional skirt or depending sidewalls 70 that extend downwardly from the bottom wall (i.e., extend downwardly from the bottom of the aperture AP and away from the punch pin) are required to provide additional strength and stability to the two piece, stamped punch housing. In the one piece housing construction of the present invention, there is no need for the additional skirt, as the one piece construction provides the requisite strength and stability. By eliminating the need for the additional skirt, the process for manufacturing the housing 20 is simplified, and further tolerancing issues are reduced.

As best shown in FIG. 5C, the slot 12 has a stack height SH, which is the distance extending between the top surface of the front portion 48 of the bottom wall 44 and the bottom surface of the intermediate wall 60. In the illustrated embodiment, the stack height SH is approximately equal to about 1.35 mm, though it is understood that other stack heights are possible and still fall within the scope of the present invention. The stack height SH determines how many sheets can be inserted into the slot 12 to be punched by the punch pin 18. In the illustrated embodiment, the slot 12 is sized to accept up to about twelve sheets.

The sidewalls 40 each include the slot 32 for receiving the cross pin 30, as well as a pivot pin aperture 64 for receiving the pivot pin 34. As mentioned above, the slot 32 is configured to allow for the requisite vertical motion of the cross pin 30 to drive the punch pin 18. The pivot pin aperture 64 is configured to allow for some horizontal motion of the pivot pin 34 during the punching operation, and the pivot pin 34 is the point about which the handle 26 rotates with respect to the base 22 and the housing 20. As best seen in FIG. 5B of the illustrated embodiment, the sidewalls 40 each have a thickness T. In the illustrated embodiment, the thickness T is approximately equal to about 2.0 mm. The thickness T of the sidewalls 40 is chosen to provide the requisite strength to the housing 20 to make the housing usable for punching an increased number of sheets (e.g., about twelve sheets). In other embodiments, the thicknesses T of the two sidewalls 40 can differ, such that one sidewall 40 is thicker than the other.

The pivot pin aperture 64 is an enclosed aperture, rather than an open slot. In prior art multiple piece housing configurations, such as the two piece housing 20P in FIG. 10, the pivot pin slot 64P is an open ended slot. By having an enclosed pivot pin aperture 64 in the housing 20 according to the present invention, the overall strength and structural integrity of the walls 40 is increased, such that the housing can be cast of a softer material (such as a zinc alloy).

The improved strength of the punch housing 20 is also reflected in the ratio of the sidewall thickness T to the stack height SH. To achieve adequate strength, the ratio should be greater than 0.9, and the ratio is preferably greater than or equal to 1. In one embodiment, the ratio is greater than or equal to 1.4 and less than or equal to 1.6. In the illustrated embodiment, the ratio of T:SH is about 2 mm:1.35 mm, or about 1.48. It is understood that the ratio can vary and still fall within the scope of the present invention. Put another way, in preferred embodiments, the wall thickness T is greater than or equal to the stack height SH.

The housing 20 of the present invention is cast as a single piece, having some or all of the features discussed in detail above. The resulting integrally-formed housing is simple to construct, and reduces many of the difficulties of the prior art multiple piece constructions by reducing tolerancing and alignment concerns, and by increasing overall strength of the housing. The increased strength allows for a greater range of materials to be used in constructing the housing, as well as allowing the housing to be used in punches that can punch a greater number of sheets.

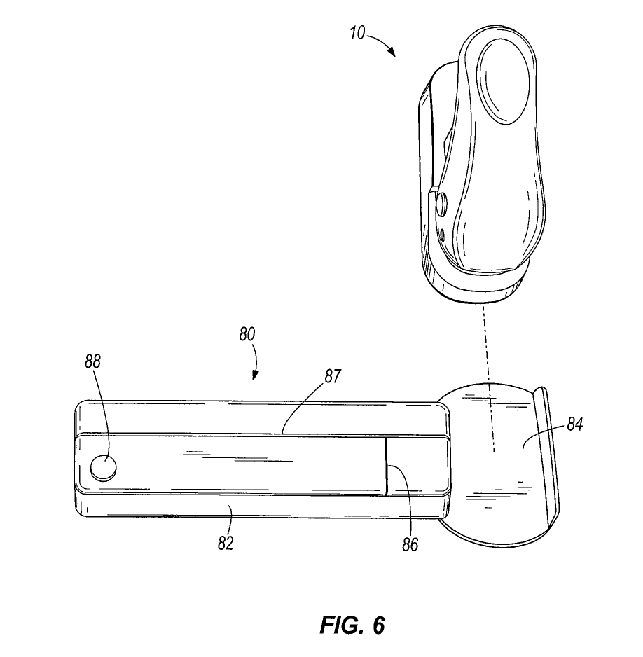

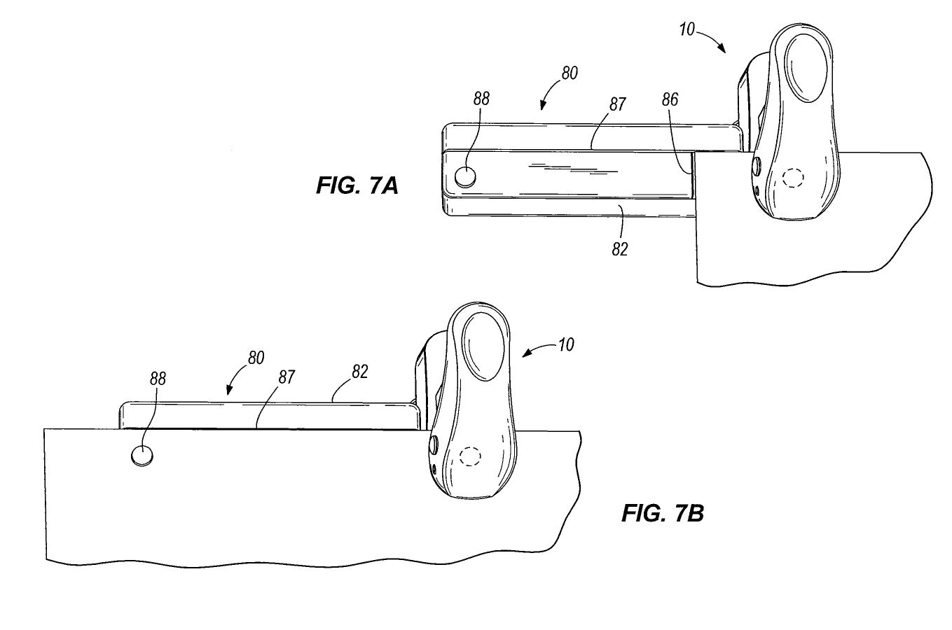

FIGS. 6, 7A, and 7B illustrate a punch guide 80 that can be used with the punch 10. The punch guide 80 includes an elongated guide portion 82 and a punch receiving portion 84. The guide portion 82 includes an alignment indicia 86, a sheet edge indicator 87, and a projection 88 that, in combination, can be used to space punched holes in a sheet at a desired spacing (e.g., a standard three-hole punch spacing). As shown in FIG. 6, the punch 10 can be inserted into the punch receiving portion 84, where it can fit with a releasable snap-fit. Next, as shown in FIG. 7A, one edge of the sheet can be aligned with the alignment indicia 86 and the intersecting edge of the sheet can be aligned with the sheet edge indicator 87, and the first hole can be punched. Next, as shown in FIG. 7B, the projection 88 can be placed in the previously-punched hole and the intersecting edge of the sheet aligned with the sheet edge indicator 87 to provide the location for the second hole to be punched. After the second hole is punched, the prior step can be repeated one more time to locate and punch a third hole. The three punched holes will be spaced so as to fit in a standard three ring binder. Of course, the punch guide 80 could alternatively be configured to yield different punch hole configurations (e.g., two-hole punch configurations).

Various features and advantages of the invention are set forth in the following claims.

What is claimed is:

1. A punch head comprising:
a punch pin; and
a punch housing supporting the punch pin, the punch housing including
a slot for receiving one or more workpieces to be punched, the slot defining a stack height SH; and
first and second walls, at least one of the first and second walls defining a wall thickness T, and each of the first and second walls including an aperture for receiving a pivot pin coupling a punch pin actuation member to the punch housing;
wherein a ratio of wall thickness T to stack height SH is greater than 0.9.

2. The punch head of claim 1, wherein the ratio of wall thickness T to stack height SH is greater than or equal to 1.

3. The punch head of claim 1, wherein the ratio of wall thickness T to stack height SH is greater than or equal to 1.4 and less than or equal to 1.6.

4. The punch head of claim 3, wherein the ratio of wall thickness T to stack height SH is about 1.48.

5. The punch head of claim 1, wherein the punch housing is a one-piece, integrally-formed part.

6. The punch head of claim 5, wherein the punch housing is cast from a zinc alloy.

7. The punch head of claim 1, wherein the aperture in each of the first and second walls is an enclosed aperture.

8. The punch head of claim 1, wherein the slot is defined between third and fourth walls of the punch housing, each of the third and fourth walls including an aperture configured to receive the punch pin, one of the apertures in the third and fourth walls defining a cutting edge that cooperates with the punch pin.

9. The punch head of claim 8, wherein the one of the third and fourth walls that includes the aperture defining the cutting edge is generally planar with no skirt or sidewalls extending therefrom in a direction away from the punch pin.

10. The punch head of claim 1, wherein the first and second walls each further include a second aperture for receiving a cross pin coupled with the punch pin and the actuation member to impart movement to the punch pin upon movement of the actuation member.

11. A punch comprising:
a base,
a punch head supported on the base, the punch head including
a punch pin; and
a punch housing supporting the punch pin, the punch housing including
a slot for receiving one or more workpieces to be punched, the slot defining a stack height SH; and
first and second walls, at least one of the first and second walls defining a wall thickness T, and each of the first and second walls including an aperture; and
an actuation member coupled to the punch housing via a pivot pin received in the apertures in the first and second walls;
wherein a ratio of wall thickness T to stack height SH is greater than 0.9.

12. The punch of claim 11, wherein the ratio of wall thickness T to stack height SH is greater than or equal to 1.

13. The punch of claim 11, wherein the ratio of wall thickness T to stack height SH is greater than or equal to 1.4 and less than or equal to 1.6.

14. The punch of claim 13, wherein the ratio of wall thickness T to stack height SH is about 1.48.

15. The punch of claim 11, wherein the punch housing is a one-piece, integrally-formed part.

16. The punch of claim 15, wherein the punch housing is cast from a zinc alloy.

17. The punch of claim 11, wherein the aperture in each of the first and second walls is an enclosed aperture.

18. The punch of claim 11, wherein the slot is defined between third and fourth walls of the punch housing, each of the third and fourth walls including an aperture configured to receive the punch pin, one of the apertures in the third and fourth walls defining a cutting edge that cooperates with the punch pin.

19. The punch of claim 18, wherein the one of the third and fourth walls that includes the aperture defining the cutting edge is generally planar with no skirt or sidewalls extending therefrom in a direction away from the punch pin.

20. The punch of claim 11, wherein the first and second walls each further include a second aperture for receiving a cross pin coupled with the punch pin and the actuation member to impart movement to the punch pin upon movement of the actuation member.

21. The punch of claim 11, further comprising a second punch head supported on the base to form a two-hole punch.

22. The punch of claim 11, further comprising second and third punch heads supported on the base to form a three-hole punch.

23. The punch of claim 11, further comprising a punch guide releasably attached to the base to facilitate punching multiple holes at a desired spacing.

24. A punch comprising:
a base,
a punch head supported on the base, the punch head including
a punch pin; and
a one-piece, integrally-formed punch housing supporting the punch pin,
the punch housing including
a slot for receiving one or more workpieces to be punched, the slot defining a stack height SH; and
first and second walls, each defining a wall thickness T, and each including a first aperture for receiving a cross pin extending through an aperture in the punch pin, and a second aperture; and
an actuation member coupled to the punch housing via a pivot pin received in the second apertures in the first and second walls, and coupled to the cross pin to impart movement to the punch pin upon movement of the actuation member;
wherein a ratio of wall thickness T to stack height SH is greater than 0.9.

25. The punch of claim 24, wherein the punch housing is cast from a zinc alloy.
